(19) United States
(12) Patent Application Publication
(10) Pub. No.: US 2013/0231851 A1
(43) Pub. Date: Sep. 5, 2013

(54) ELECTRONIC DEVICE AND METHOD FOR PROVIDING TRAFFIC INFORMATION TO MOBILE DEVICES

(71) Applicant: FIH (HONG KONG) LIMITED, Kowloon (HK)

(72) Inventor: CHENG-HAO CHEN, New Taipei (TW)

(73) Assignee: FIH (HONG KONG) LIMITED, Kowloon (HK)

(21) Appl. No.: 13/757,883

(22) Filed: Feb. 4, 2013

(30) Foreign Application Priority Data
Mar. 2, 2012 (TW) 101107117

(51) Int. Cl. G08G 1/00

(52) U.S. Cl. CPC G08G 1/00
USPC 701/119; 701/117

(57) ABSTRACT

In an electronic device and a method for providing traffic information, traffic information of all roads are acquired from a traffic information server, then the traffic information is analyzed to obtain basic information of each road. When a service that provides traffic information of one or more roads is subscribed to by a mobile device, the electronic device sends the basic traffic information of the one or more roads to the mobile device.

### BACKGROUND

1. Technical Field

Embodiments of the present disclosure generally relate to traffic information processing devices and methods, and particularly to an electronic device and a method for providing traffic information to mobile devices.

2. Description of Related Art

When driving a car or walking on the road, people may encounter different traffic conditions, for example, road under-construction, landslide, traffic control, traffic jam, bridge closed, etc. In these cases, people may have to make a detour.

In order to avoid passing through the locations where particular traffic conditions occurred, people may receive traffic condition on radio stations or dial a service telephone number to receive a voice traffic condition report. However, in order to meet public requirements, regular radio station traffic condition broadcasting or telephone voice traffic condition report provides traffic condition information of a broad geographic zone. This traffic condition broadcasting or telephone voice traffic condition report service cannot provide the traffic condition information of the geographic location of every individual to meet individual's needs.

### BRIEF DESCRIPTION OF THE DRAWINGS

FIG. 1 is a block diagram illustrating one embodiment of an electronic device.

FIG. 2 is a block diagram illustrating function modules of a traffic information processing system included in the electronic device of FIG. 1.

FIG. 3 is a flowchart illustrating one embodiment of a method for subscribing to a service that provides traffic information by a mobile device.

FIG. 4 is a flowchart illustrating one embodiment of a method for processing traffic information by the electronic device.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may be comprised of connected logic units, such as gates and flip-flops, and may be comprised of programmable units, such as programmable gate arrays or processors. The modules described herein may be implemented as either software and/or hardware modules and may be stored in any type of non-transitory computer-readable medium or other computer storage device.

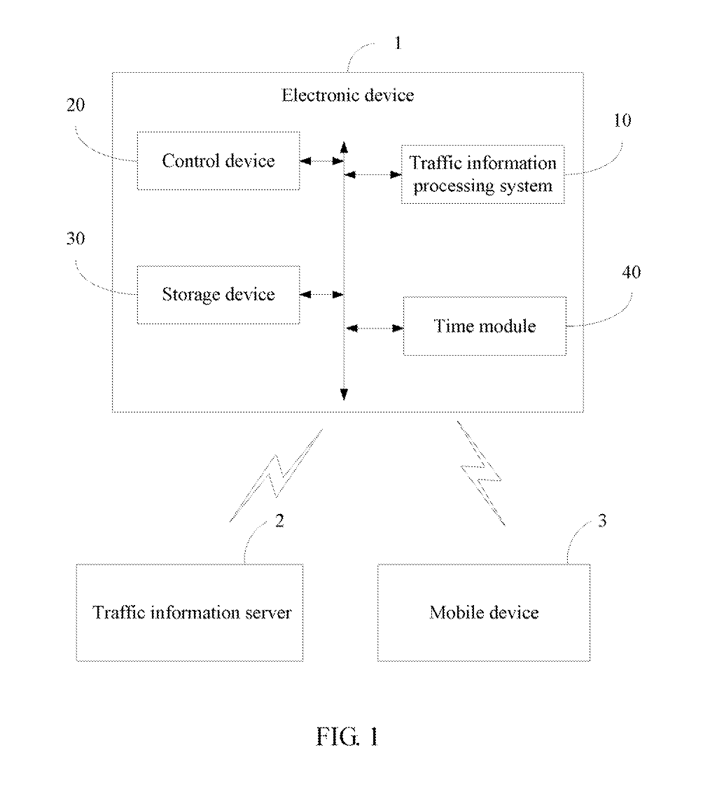

FIG. 1 is a block diagram illustrating one embodiment of an electronic device 1. The electronic device 1 can be a computer, a server, for example. The electronic device 1 includes components, such as a traffic information processing system 10, a control device 20, a storage device 30, and a time module 40. These components 10-40 communicate over one or more communication buses or signal lines. The electronic device 1 may have more or fewer components than shown in FIG. 1, or a different configuration of components. The various components shown in FIG. 1 may be implemented in hardware, software or a combination thereof, including one or more signal processing and/or application specific integrated circuits.

The electronic device 1 communicates with a traffic information server 2 and one or more mobile devices 3 through a network, such as a wireless network or the Internet. The traffic information server 2 stores real time traffic information of all roads in a geographic zone. The geographic zone may be a city or a country, for example. The traffic information of a road may include, such as a road name, a starting point and an ending point of the road, direction and speed of traffic on the road. In one embodiment, the traffic information may be in an XML format, such as:

```
<locate>
    <name> XX </name>
    <point_s> YY </point_s>
    <point_e> ZZ </point_e>
    <direction> East </direction>
    <speed> NN </speed>
  </locate>.
```

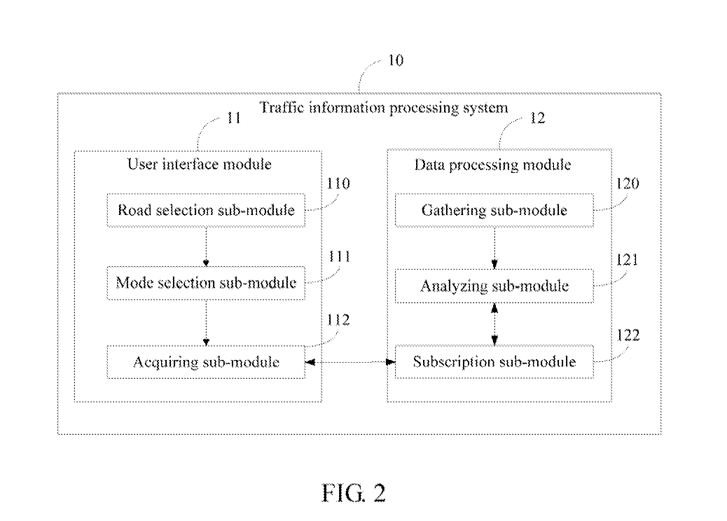

The traffic information processing system 10 includes a plurality of function modules (see below descriptions that refer to FIG. 2), to obtain traffic information from the traffic information server 2, analyze the traffic information, and send individual traffic information to mobile devices 3 according to individual's needs.

The function modules of the traffic information processing system 10 may include one or more computerized codes in the form of one or more programs that are stored in the storage device 30, and executed by the control device 20, to provide functions for the function modules of the traffic information processing system 10. The storage device 30 may include some type(s) of non-transitory computer-readable storage mediums, such as a memory, a hard disk drive, a compact disc, a digital video disc, or a tape drive. The control device 20 may be a processor, a microprocessor, for example.

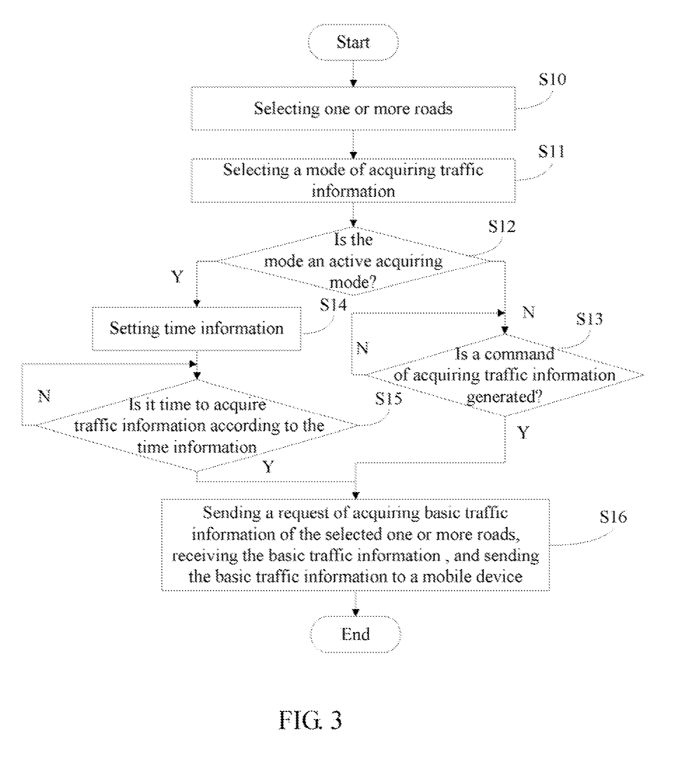

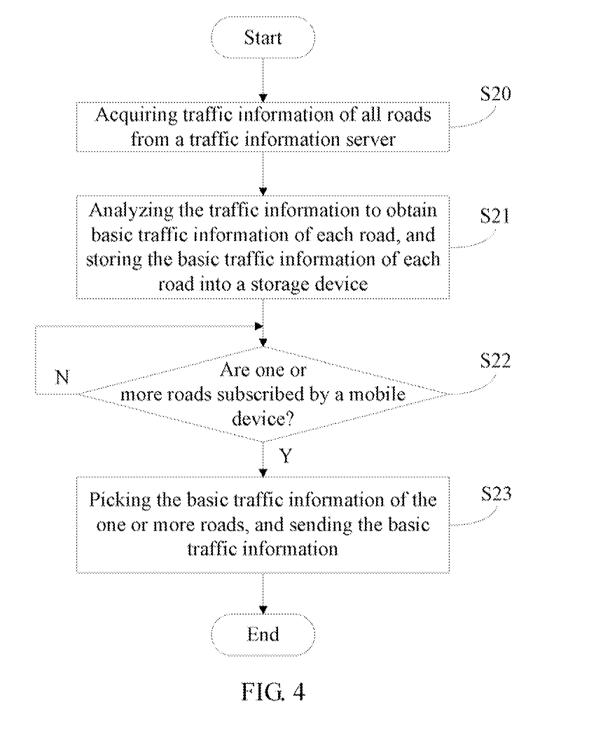

FIG. 2 is a block diagram illustrating the function modules of the traffic information processing system 10. The function modules of the traffic information processing system 10 may include a user interface module 11 and a data processing module 12. The user interface module 11 performs a method for subscribing to a service that provides traffic information by one of the mobile devices (hereinafter, the mobile device) 3, as described in FIG. 3. The data processing module 12 performs a method for processing traffic information, as described in FIG. 4. The user interface module 11 may include a road selection sub-module 110, a mode selection sub-module 111, and an acquiring sub-module 112. The data processing module 12 may include a gathering sub-module 120, an analyzing sub-module 121, and a subscription module 122. The function modules 110-112 and 120-122 provide at least the functions needed to execute the steps illustrated in FIG. 3 and FIG. 4.

FIG. 3 is a flowchart illustrating one embodiment of a method for subscribing to a service that provides traffic information by the mobile device 3 using the user interface module 11. Depending on the embodiment, additional steps may be added, others removed, and the ordering of the steps may be changed.

In step S10, the road selection sub-module 110 selects one or more roads. In one embodiment, the roads are selected according to a selection of a user of the mobile device 3. In one embodiment, the traffic information processing system 10 may provide a road list which provides road names on a display device of the mobile device 3. The user can select one or more road from the road list by using an input device of the mobile device 3, or by touching a touch screen of the mobile device 3.

In step S11, the mode selection sub-module 111 selects a mode of acquiring traffic information of the selected roads. In one embodiment, the mode is selected a selection made by the user of the mobile device 3. In one embodiment, the mode may include an active acquiring mode and a passive acquiring mode. The active acquiring mode means that the traffic information is actively acquired according to preset time information, such as a time point, a time interval. The time point may be, for example, 8:00 AM every day, and the time interval may be every 10 minutes for example. The passive acquiring mode means the traffic information is passively acquired according to the user's command. In one embodiment, the traffic information processing system 10 may provide options on the display device of the mobile device 3 for the user to select the active acquiring mode and the passive acquiring mode.

In step S12, the mode selection sub-module 111 determines if the selected mode is the active acquiring mode. Step 13 is implemented if the selected mode is the passive acquiring mode. Otherwise, steps S14 and S15 are implemented if the selected mode is the active acquiring mode.

In step S13, the acquiring sub-module 112 determines if a command of acquiring traffic information is generated. In one embodiment, the command of acquiring traffic information is generated according to the user operation. As mentioned above, the traffic information processing system 10 may provide options for the user to select the active acquiring mode or the passive acquiring mode. When the user selects the active acquiring mode or the passive acquiring mode from the options, the command of acquiring traffic information is generated, then, step S16 is implemented. Otherwise, if the user does not select any one of the options, step S13 is repeated.

In step S14, the acquiring sub-module 112 sets time information of acquiring the traffic information. In one embodiment, the time information is set according to the user's setting. As mentioned, the time information may be a time point or a time interval. The time point may be, such as 8:00 AM every day, and the time interval may be every 10 minutes, for example.

In step S15, the acquiring sub-module 112 obtains a current time from the time module 50, and determines if it is time to acquire the traffic information according to the current time and the time information. If it is time to acquire the traffic information, step S16 is implemented. Otherwise, if is not yet the time to acquire traffic information, step S15 is repeated.

In step S16, the acquiring sub-module 112 sends a request of acquiring basic traffic information of the selected one or more roads to the data processing module 12, and receives the basic traffic information of the selected one or more roads from the data processing module 12, sends the basic traffic information to the mobile device 3.

FIG. 4 is a flowchart illustrating one embodiment of a method for processing traffic information using the data processing module 12. Depending on the embodiment, additional steps may be added, others removed, and the ordering of the steps may be changed.

In step S20, the gathering sub-module 120 acquires real time traffic information of all roads from the traffic information server 2. As mentioned, the traffic information includes such as a road name, a starting point and an ending point of each road, direction and speed of traffic on each road, the traffic information is stored in an XML format.

In step S21, the analyzing sub-module 121 analyzes the traffic information to obtain the basic information of each road, and stores the basic traffic information of each road into the storage device 30. The basic traffic information of a road includes a road name, a stating point and an ending point of the road, a direction and a speed of the road.

In one embodiment, the analyzing sub-module 121 obtains the basic information of the road according to XML labels, such as <name>, <point_s>, <point_e>, <direction>, and <speed>.

In step S22, the subscription sub-module 122 determines if a service that provides traffic information of one or more roads are subscribed to by the mobile device 3. In one embodiment, when the subscription sub-module 122 receives the request of acquiring basic traffic information of one or more roads, the subscription sub-module 122 determines that a service that provides traffic information of the one or more roads are subscribed to by the mobile device 3, and step S23 is implemented. Otherwise, if no service that provides traffic information of roads is subscribed by the mobile device 3, step S22 is repeated.

In step S23, the subscription sub-module 122 picks the basic traffic information of the one or more roads from the storage device 30, and sends the basic traffic information to the user interface module 11.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for providing traffic information to mobile devices, the method being performed by execution of computer readable program code by a processor of an electronic device, the method comprising:
acquiring traffic information of all roads from a traffic information server;
analyzing the traffic information to obtain basic traffic information of each road, and storing the basic traffic information of each road to a storage device of the electronic device; and
picking the basic traffic information of one or more roads which is subscribed to by a mobile device from the storage device of the electronic device, and sending the basic traffic information to the mobile device.

2. The method as described in claim 1, wherein the traffic information of all roads are stored in the traffic information server in an XML format, and the traffic information is analyzed according to XML labels.

3. The method as described in claim 1, wherein the basic information of each road comprises: road name, a starting point and an ending point of each road, direction and speed of traffic on each road.

4. The method as described in claim 1, before the obtaining step, the method further comprising:
sending a request of acquiring the basic traffic information of the one or more roads.

5. The method as described in claim 4, wherein the request is generated passively according to a command of a user of the mobile device.

6. The method as described in claim 4, wherein the request is generated actively according to preset time information.

7. A non-transitory storage medium having stored thereon instructions that, when executed by a processor of an electronic device, cause the electronic device to perform a method for providing traffic information to mobile devices, the method comprising:
acquiring traffic information of all roads from a traffic information server;
analyzing the traffic information to obtain basic traffic information of each road, and storing the basic traffic information of each road to a storage device of the electronic device; and
picking the basic traffic information of one or more roads which is subscribed to by a mobile device from the storage device of the electronic device, and sending the basic traffic information to the mobile device.

8. The non-transitory storage medium as described in claim 7, wherein the traffic information of all roads are stored in the traffic information server in an XML format, and the traffic information is analyzed according to XML labels.

9. The non-transitory storage medium as described in claim 7 wherein the basic traffic information of each road comprises: road name, a starting point and an ending point of each road, direction and speed of traffic on each road.

10. The non-transitory storage medium as described in claim 7, wherein, before the obtaining step, the method further comprises:
sending a request of acquiring the basic traffic information of the one or more roads.

11. The non-transitory storage medium as described in claim 10, wherein the request is generated passively according to a command of a user of the mobile device.

12. The non-transitory storage medium as described in claim 10, wherein the request is generated actively according to preset time information.

13. An electronic device, comprising:
at least one processor;
a storage device;
one or more programs that are stored in the storage device and are executed by the at least one processor, the one or more programs comprising:
a gathering sub-module that acquires traffic information of all roads from a traffic information server;
an analyzing sub-module that analyzes the traffic information to obtain basic traffic information of each road, and stores the basic traffic information of each road into the storage device; and
a subscription sub-module that picks the basic traffic information of one or more roads which is subscribed to by a mobile device from the storage device to send the basic traffic information to the mobile device.

14. The electronic device as described in claim 13, wherein the traffic information of all roads are stored in the traffic information server in an XML format, and the traffic information is analyzed according to XML labels.

15. The electronic device as described in claim 13, wherein the basic traffic information of each road comprises: road name, a starting point and an ending point of each road, direction and speed of traffic on each road.

16. The electronic device as described in claim 13, wherein the one or more programs further comprises:
a road selection sub-module that selects the one or more roads;
a mode selection sub-module that selects a mode of acquiring the traffic information; and
an acquiring sub-module that sends a request of acquiring the basic traffic information of the one or more roads according to the selected mode, and receives the basic traffic information of the selected one or more roads from the data processing module and send the basic traffic information of the selected one or more roads to the mobile device.

17. The electronic device as described in claim 16, wherein the mode comprises an active acquiring mode and a passive acquiring mode.
